(19) United States
(12) Patent Application Publication
(10) Pub. No.: US 2011/0150502 A1
(43) Pub. Date: Jun. 23, 2011

(54) HIGH-SPEED OPTICAL TRANSMITTERS USING CASCADED OPTICALLY INJECTION-LOCKED LASERS

(75) Inventors: Xiaoxue Zhao, Albany, CA (US); Erwin K. Lau, Berkeley, CA (US); Ming C. Wu, Moraga, CA (US); Connie Chang-Hasnain, Palo Alto, CA (US); Hyuk-Kee Sung, Albany, CA (US); Devang Parekh, Berkeley, CA (US)

(73) Assignee: THE REGENTS OF THE UNIVERSITY OF CALIFORNIA, Oakland, CA (US)

(21) Appl. No.: 12/561,947

(22) Filed: Sep. 17, 2009

Related U.S. Application Data
(63) Continuation of application No. PCT/US2008/057541, filed on Mar. 19, 2008.
(60) Provisional application No. 60/895,629, filed on Mar. 19, 2007.

(51) Int. Cl. H04B 10/04

(52) U.S. Cl. 398/188; 398/183

(57) ABSTRACT

Apparatus and method for increasing optical transmission bandwidth in response to chaining, in cascade, one or more slave lasers onto a master laser. Each laser is configured for optical injection locking (OIL) and each slave laser is locked onto the master laser. The first and each subsequent slave laser are detuned to tailor frequency characteristics of apparatus output. The transmitter can be scaled up by cascading additional injection-locked lasers together. The invention supports multiple compatible modulation formats, such as amplitude modulation (AM), phase modulation (PM), and frequency modulation (FM), for tailoring the output to the application of interest, while any type of laser can be used for the master and slave lasers.

### CROSS-REFERENCE TO RELATED APPLICATIONS

This application claims priority from, and is a 35 U.S.C. §111(a) continuation of, co-pending PCT international application serial number PCT/US2008/057541, filed on Mar. 19, 2008, incorporated herein by reference in its entirety, which in turn claims priority from U.S. provisional application Ser. No. 60/895,629 filed on Mar. 19, 2007, incorporated herein by reference in its entirety.

This application is also related to PCT International Publication No. WO 2008/116014 published on Sep. 25, 2008 and republished on Nov. 20, 2008, incorporated herein by reference in its entirety.

### STATEMENT REGARDING FEDERALLY SPONSORED RESEARCH OR DEVELOPMENT

This invention was made with Government support under Grant No. W911 NF-06-1-0269 awarded by the DARPA aPropos. The Government has certain rights in this invention.

### INCORPORATION-BY-REFERENCE OF MATERIAL SUBMITTED ON A COMPACT DISC

Not Applicable

### NOTICE OF MATERIAL SUBJECT TO COPYRIGHT PROTECTION

A portion of the material in this patent document is subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. §1.14.

### BACKGROUND OF THE INVENTION

1. Field of the Invention

This invention pertains generally to optical transmitters, and more particularly to bandwidth enhancement of optically injection-locked (OIL) lasers.

2. Description of Related Art

Digital optical communications are critical elements within the present-day communications infrastructure. Substantial interest continues toward developing lower cost optical transmitters which can support very high communication rates. One recent technique for improving communication speeds has been found in optical injection locking (OIL), which has been utilized for boosting the resonance frequency of semiconductor lasers. However, it is desirable to further extend communication rates.

Accordingly, the present invention teaches new apparatus and methods for extending communication frequency range and bandwidth for laser optical transmitters.

### BRIEF SUMMARY OF THE INVENTION

Apparatus and methods are described for chaining one or more slave lasers (in series) onto a master laser toward extending the bandwidth of the optical transmission. The lasers are configured for optical injection locking with each slave laser locked onto the master laser. The first and each subsequent slave laser are detuned to tailor frequency characteristics of the output. The chain configuration provides a means toward achieving very high-speed tailored frequency response using relatively low-frequency (and low cost) components. The system can be scaled up by cascading multiple injection-locked lasers together. Any means of injection locking the lasers can be utilized. For example circulator devices can be utilized, or for greater simplicity and lower costs, the circulators can be replaced by power splitters between the different stages, which also simplifies integrating the optical devices on a chip. The invention can support multiple modulation formats, such as amplitude, phase, and frequency modulation, for tailoring the output to the application of interest. There are no significant constraints on the type of laser to be used for either the master or the slave lasers, these may be any convenient types, such as DFB lasers, VCSELs, simple Fabry-Perot lasers, or even microring-cavity lasers.

The invention is amenable to being embodied in a number of ways, including but not limited to the following descriptions and combinations thereof.

One embodiment of the invention is an apparatus for optical transmission, comprising: (a) a master laser which supports optical injection locking (OIL); (b) at least one slave laser cascaded upon the master laser, in which the slave laser supports optical injection locking (OIL) and is configured for being injection-locked by the master laser; (c) means for frequency detuning a first slave laser and each subsequent slave laser within the at least one laser, and wherein the detuning is performed across the locking range of the associated laser; and (d) means for modulating the input of the master laser. It will be appreciated that increasing the available bandwidth for optical transmission is one of the principle benefits of the invention. It should also be recognized that the present invention can provide a very high-frequency response while relying on the use of relatively low-frequency components. For example, the highest frequency of modulation can be on the order of at least 2-5 times the frequency of the low-frequency components utilized (e.g., the 3-dB bandwidths of the devices in the apparatus). By way of example, in the embodiments described the very high-frequency response is greater than 50 GHz while utilizing relatively low-frequency devices, such as 10 GHz slave lasers and 25 GHz external modulators.

The available bandwidth for the apparatus is increased with resonance peaks created for each slave laser connected in cascade with the master laser, with the total frequency response being provided in response to radio-frequency (RF) amplification from the shifted slave laser devices. It will be appreciated that the injection-locked lasers (OIL) provide single-sideband amplification of the modulation.

In at least one implementation of the invention, optical injection locking is provided in response to the use of optical circulators, power splitters, or similar components which are configured for injection-locking the slave lasers.

In at least one implementation of the invention, each of the optical elements in the apparatus is configured for maintaining or controlling the polarization.

In one implementation of the invention the master laser is externally modulated using a Mach-Zehnder interferometer and provides sufficient optical output power to lock onto the slave laser having the largest detuning value. The first of the slave lasers connected to the master laser is configured for direct modulation.

In at least one mode of the invention the master laser and the slave lasers can be either directly or externally modulated according to any compatible combination of amplitude modulation (AM), phase modulation (PM), and frequency modulation (FM). The modulations are compatible if the output modulation format of one slave laser is matched to the input modulation source of the next slave laser.

In at least one mode of the invention the master laser is externally modulated and/or one or more slave lasers in the cascade are directly modulated.

In at least one implementation of the invention, the master and slave lasers are selected from the group of semiconductor lasers consisting of distributed feedback lasers (DFB), vertical cavity surface-emitting lasers (VCSELs), Fabry-Perot lasers, and microring-cavity lasers.

In at least one mode of the invention, the detuning between the master and the slaves is adjusted and used in combination with injection power level tuning, to tailor frequency response toward either damped low resonance frequency or peaked high resonance frequency.

One embodiment of the invention is a method of increasing bandwidth of an optical transmission, comprising: (a) configuring a master laser for optical injection locking (OIL); (b) connecting at least one slave laser to the master laser; (c) optical injection locking of one or more slave lasers in response to injection locking by the master laser; (d) frequency detuning a first slave laser and each subsequent slave laser in the cascade, wherein the detuning is performed across the locking range of the associated laser; and (e) modulating the input of the master laser whereby the optical transmission output of the method comprises modulation of the master laser and each of the slave lasers.

The present invention provides a number of beneficial aspects which can be implemented either separately or in any desired combination without departing from the present teachings.

An aspect of the invention provides for increasing the bandwidth of an optical transmitter.

Another aspect of the invention is the connection of one or more slave lasers in cascade (series) to a master laser.

Another aspect of the invention is the injection locking of these slave lasers to the master laser.

Another aspect of the invention is detuning the first and each subsequent slave laser to control the frequency response of the cascaded combination of lasers.

Another aspect of the invention is detuning the slave lasers to a desired extent within their locking range.

Another aspect of the invention is extending the bandwidth provided either by a master laser or a slave laser in response to the cascade arrangement of the additional slave lasers.

Another aspect of the invention is the use of various formats of modulation, separately or in combination, including amplitude modulation (AM), frequency modulation (FM), and phase modulation (PM).

A still further aspect of the invention is the use of any type of laser diode that can be configured for optical injection locking (OIL), including but not limited to distributed feedback lasers (DFB), vertical cavity surface-emitting lasers (VCSELs), Fabry-Perot lasers, and microring-cavity lasers.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWING(S)

The invention will be more fully understood by reference to the following drawings which are for illustrative purposes only:

FIG. 1A-1B are schematics of test configurations of cascaded OIL configurations according to an aspect of the present invention, showing two slave lasers cascaded to a master laser with the use of an interferometer in FIG. 1B.

FIG. 2A-2B are graphs of frequency response and optical spectrum for the schematic of FIG. 1A.

FIG. 3 is a graph of frequency response for 0, 1 and 2 OIL-VCSELs according to aspects of the present invention and schematic shown in FIG. 1B.

FIG. 4 is a schematic of cascaded lasers along with representative optical spectrum and frequency response waveforms shown in relation to the number of cascaded lasers utilized.

FIG. 5 is a graph of frequency response for fixed injection power and various levels of frequency detuning across the locking range of the laser according to aspects of the present invention.

FIG. 6 is a graph of phase input modulation and phase output across various levels of frequency detuning across the locking range of the laser according to aspects of the present invention.

FIG. 7 is a graph of phase input modulation and amplitude output across various levels of frequency detuning across the locking range of the laser according to aspects of the present invention.

FIG. 8 is a graph of direct input modulation and amplitude output across various levels of frequency detuning across the locking range of the laser according to aspects of the present invention.

FIG. 9 is a graph of direct input modulation and phase modulated output across various levels of frequency detuning across the locking range of the laser according to aspects of the present invention.

FIG. 10 is a graph of frequency response showing output with phase modulation only (PM) compared with OIL enhanced output, according to an aspect of the present invention.

FIG. 11 is a graph of frequency response for a transmitter using 1.55 μm VCSELs mounted on temperature controlled copper blocks according to an aspect of the present invention.

### DETAILED DESCRIPTION OF THE INVENTION

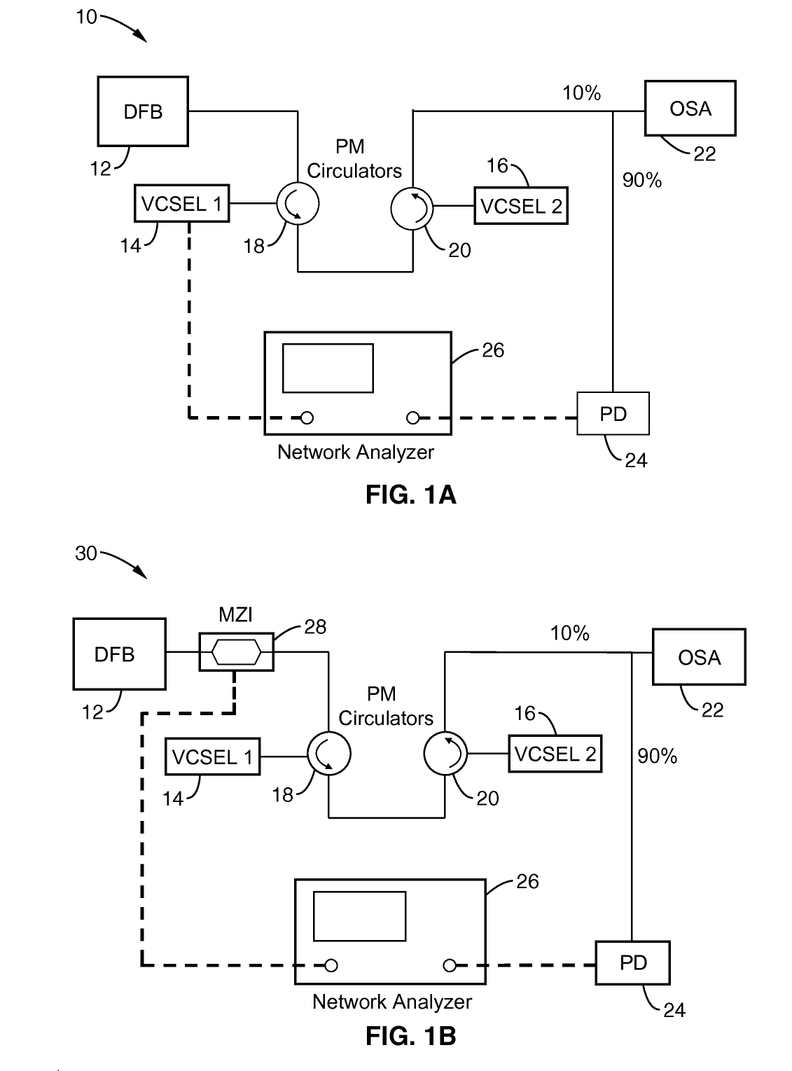

Referring more specifically to the drawings, for illustrative purposes the present invention is embodied in the apparatus generally shown in FIG. 1 through FIG. 11. It will be appreciated that the apparatus may vary as to configuration and as to details of the parts, and that the method may vary as to the specific steps and sequence, without departing from the basic concepts as disclosed herein.

The use of very high-speed, low-cost optical transmitters are critical components for next generation 100-Gb/s Ethernet and local area networks (LANs). Optical injection locking (OIL) has been shown to be a very effective technique to increase the resonance frequency, and thus the bandwidth of directly-modulated semiconductor lasers. The inventors have previously reported optical communication based on OIL which provided a maximum 3-dB bandwidth of 44 GHz with a record resonance frequency at 72 GHz on an injection-locked distributed feedback (DFB) laser, and also demonstrated very significant dynamic performance improvement on injection-locked vertical-cavity surface-emitting lasers (VCSELs). In this work it also has been shown that the injection-locked laser cavity operates similarly to a red-shifted optical amplifier in the high-power injection regime, thus providing strong single-sideband amplification of the modulation signal up to a frequency range that is close to one order of magnitude higher than that of free-running lasers.

The present invention teaches mechanisms for leveraging the bandwidth enhancement of directly-modulated lasers using OIL, in response to a technique whereby additional injection-locked lasers are cascaded so as to push the modulation bandwidth to even higher levels. This novel configuration provides a number of advantages over current technologies. In addition, the teachings are further extended by utilizing the amplifier effect of the OIL-laser to substantially extend the bandwidth of an externally-modulated master laser using cascaded injection-locked lasers. Furthermore, this approach has the potential to be scaled up by cascading additional lasers in a daisy chain, all being injection-locked by a single master laser, with modulation signals applied directly to one or multiple lasers, or the master laser toward eventually achieving ultra-high bandwidth modulation. Numerical simulation shows that different modulation formats, such as phase modulation (PM), or frequency modulation (FM) would result in similar modulation bandwidth enhancement as observed in amplitude modulation (AM) on either slave lasers or the master laser. Therefore, different modulation formats can be incorporated to the cascaded OIL-laser scheme to achieve high-speed optical transmitters.

FIG. 1A-1B are example embodiments 10, 30, of two different cascaded OIL-VCSEL transmitters. Each figure is shown with the master laser 12 at the left, exemplified as a distributed-feedback (DFB) laser, coupled through multiple slave laser devices 14, 16, (e.g., VCSELs) with the output shown by way of example coupled to an optical spectrum analyzer (OSA) 22 for these tests. In this example embodiment, optical injection locking is configured using optical circulators 18, 20. All optical components are preferably polarization maintaining. A photodetector (PD) (e.g., photodiode) 24 is shown receiving a portion of the output signal which is coupled to a signal analyzer 26. In these figures the solid lines depict optical paths, while the dashed lines indicate electrical paths.

A more general depiction of the cascaded OIL transmitter configuration is shown in FIG. 4 with a master laser shown coupled through one or more slave lasers, showing up to N slave laser devices in cascade.

Returning to FIG. 1A, the modulation signal is imposed onto the first VCSEL via direct current modulation, whereas in FIG. 1B the modulation signal is delivered by externally modulating an interferometer, such as a Mach-Zehnder interferometer (MZI).

By way of example and not limitation, both example embodiments (FIGS. 1A and 1B) are shown utilizing a master laser comprising a commercial DFB laser, such as with output power up to 60 mW for ultra-high injection study. For the sake of illustration, the VCSELs are ˜1.55 μm with a buried tunnel junction (BTJ) structure designed for high speed operation, and are wire-bonded onto surface mount assembly (SMA) mounts which introduce a limiting parasitic response to the system.

The test setup is shown by way of example to aid in understanding of the configuration for making the measurements described herein. Verification of frequency response is shown being measured by a network analyzer (e.g., Agilent E8361A network analyzer). The RF cable utilized in the verification setup shown provided a 3-dB bandwidth about 40 GHz, while the photodetector provided a 3-dB bandwidth of approximately 32 GHz. The MZI used in the second scheme shown in FIG. 1B provided a 3-dB bandwidth about 40 GHz. No bias or temperature control was applied to the MZI during the experiment, while 10% of the output signal was fed to an optical spectrum analyzer to monitor the injection locking condition.

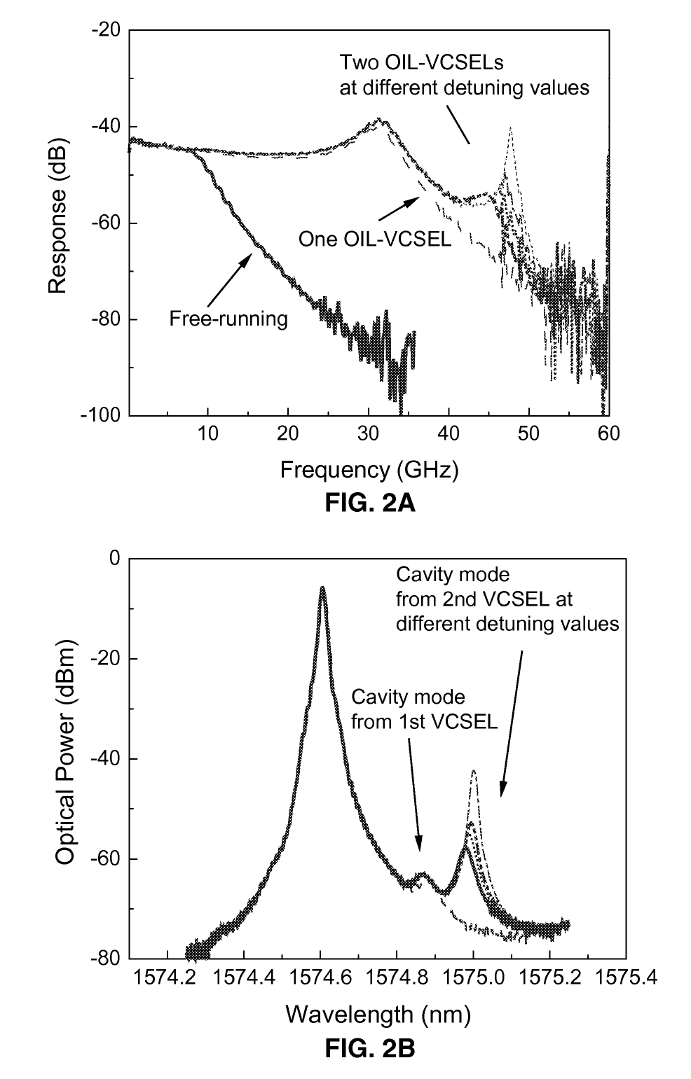

FIG. 2A-2B illustrate measured characteristics of the cascade OIL arrangement of FIG. 1A having two slave lasers. FIG. 2A depicts frequency response, while FIG. 2B depicts optical spectrum of the setup shown in FIG. 1A. As can be seen from FIG. 2A, the free-running VCSEL can be modulated up to about 10 GHz. With the first VCSEL being injection-locked by a continuous wave (CW) master laser and with the second VCSEL unbiased, a bandwidth enhancement up to 30 GHz is obtained in this configuration. The bandwidth enhancement is mainly due to the signal amplification from the VCSEL cavity, which acts as an amplifier while injection-locked. The 30 GHz resonance frequency seen in the frequency response corresponds to the VCSEL cavity mode seen in the optical spectrum shown in FIG. 2B. As has been previously demonstrated, the frequency response can be tailored to have either damped low resonance frequency or peaked high resonance frequency by adjusting the injection power and the relative detuning between the master and the slave laser.

To further enhance the modulation response, a second VCSEL can be cascaded and injection-locked by the output of the first OIL-VCSEL. According to the present invention, the detuning value is also adjusted, such as by adjusting the wavelength of the second VCSEL, so that the second VCSEL cavity is locked at a “redder” (longer) wavelength than the master laser so as to provide enhancement at frequencies beyond the resonance frequency achieved by the first OIL-VCSEL.

FIG. 2A illustrates the frequency response with cascaded OIL-VCSELs with the different line types (solid, single dash, short dash etc.) representing slight different detuning conditions of the second VCSEL to the master laser. All data shown were directly measured without removing the parasitics limited by VCSEL (10 GHz), RF cable (40 GHz), and photodetector (32 GHz). Accordingly, these graphs demonstrate that large bandwidth modulation can be obtained even when utilizing low frequency components.

FIG. 2B illustrates the optical spectra with the second VCSEL being injected-locked at a longer wavelength and at various detuning values. The detuning dependence, both in the RF and the optical domain, is the same as that for a single directly-modulated OIL-VCSEL. However, upon examining the configuration in more detail, it is noted that the second VCSEL is actually kept under continuous-wave (CW) operation and the modulation signal is provided by an equivalent modulated-master light to the second VCSEL. This result indicates that there exists no fundamental distinction between the sources of the modulation signal by using OIL-VCSELs to improve the modulation bandwidth. This assertion is further illustrated in response to the test setup shown in FIG. 1B wherein the modulation signal is carried by the master laser even for the first VCSEL. It will be noted that a 40 GHz MZI was used in the test depicted in FIG. 1B to provide modulation because the high power CW DFB laser utilized could not be directly modulated.

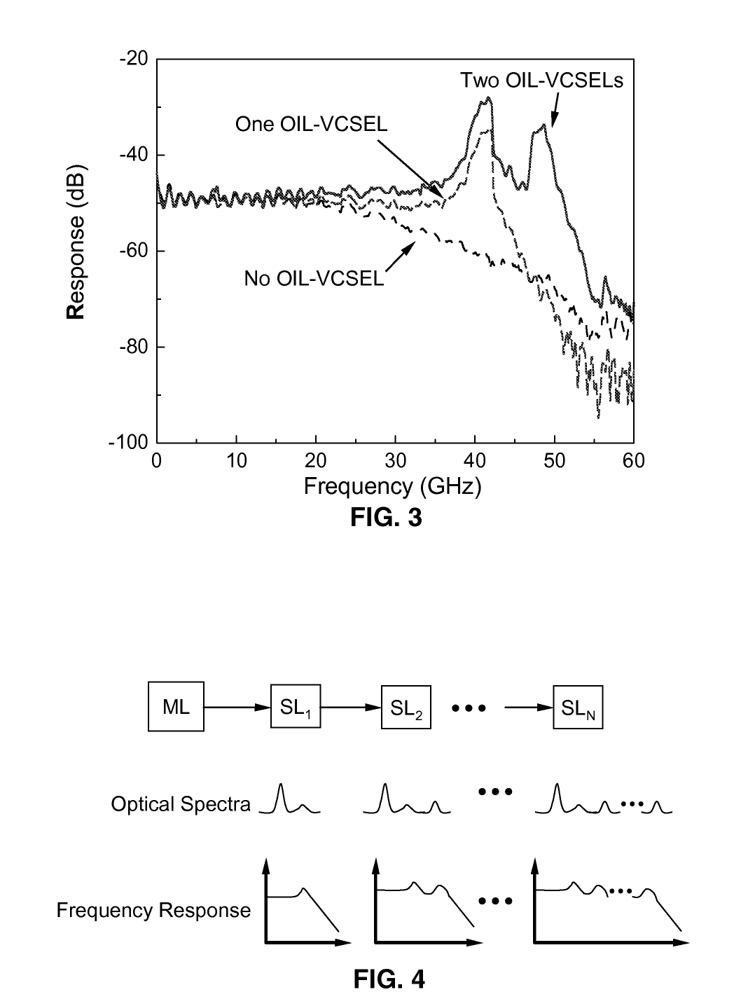

FIG. 3 illustrates measured frequency response based on directly measured data without removing known component parasitics. The lower dashed dark line shows the link response without any OIL-VCSELs. The total response in this case is limited by the photodetector which has a 3-dB point about 32 GHz. When the first VCSEL is turned on and injection-locked by the modulated master light, the response is boosted and has a bandwidth of greater than 40 GHz. When the second VCSEL is also turned on and tuned to a proper wavelength, the total response can be gained up to greater than 50 GHz. The two resonance peaks clearly seen in the total frequency response are due to the RF amplification from the two shifted VCSEL cavities.

It should be appreciated that the shape of the resonance peaks, and thus the shape of the total response, can be tailored by adjusting the injection power as well as adjusting the detuning values of the two VCSELs as mentioned previously. It should be noted that this scheme shows a better total bandwidth enhancement mainly because the link response before adding in OIL-VCSELs has a slower roll-off at high frequencies. Therefore, improved performance is expected by engineering the first VCSEL device to have a relative slow parasitic roll-off.

FIG. 4 illustrates a schematic (top) along with optical spectra and frequency response for a cascaded OIL system of any desired depth. It will be appreciated that this system can be scaled up by cascading additional slave lasers in a daisy chain, insofar as the master laser provides sufficient power to lock onto the slave laser that has the largest detuning value.

The present invention demonstrates that by cascading multiple injection-locked lasers, the 3-dB bandwidth of the total system can be increased. The technique relies on the fact that modulation on the light injected into the subsequent laser is enhanced by the resonance peak of the injection-locked laser. This enhanced modulated light can then be used for injection into the next laser and so on. By way of example, this technique was experimentally demonstrated by applying amplitude modulation (AM) to the master light and detecting the enhanced AM at the output of the slave, as was shown experimentally in FIG. 2A. It will be appreciated, however, that the present invention can be utilized with other forms of modulation, including frequency and phase modulation techniques since the resonant enhancement is similar for all of these cases.

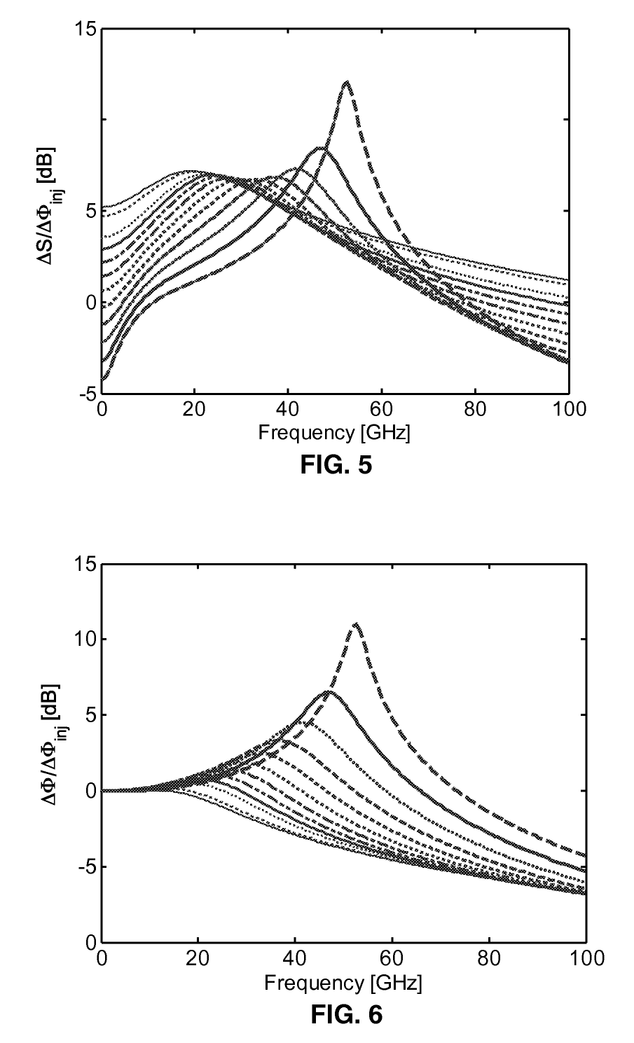

FIG. 5 depicts a family of representative frequency responses for a fixed injection power and various frequency detuning values across the locking range of the laser. The bold dashed line (highest peak) represents blue-shifted detuning while the narrowest smaller dashed lines toward the thin solid line represents red-shifted detuning. Although amplitude modulation (AM) is shown, the system can utilize phase modulation (PM), frequency modulation (FM), or a combinations thereof as input or output. For example, a phase modulator could be utilized to externally modulate the master laser before injection. The phase modulated signal would then be resonantly-amplified by the injection-locked laser, resulting in both phase and amplitude modulation output from the OIL laser.

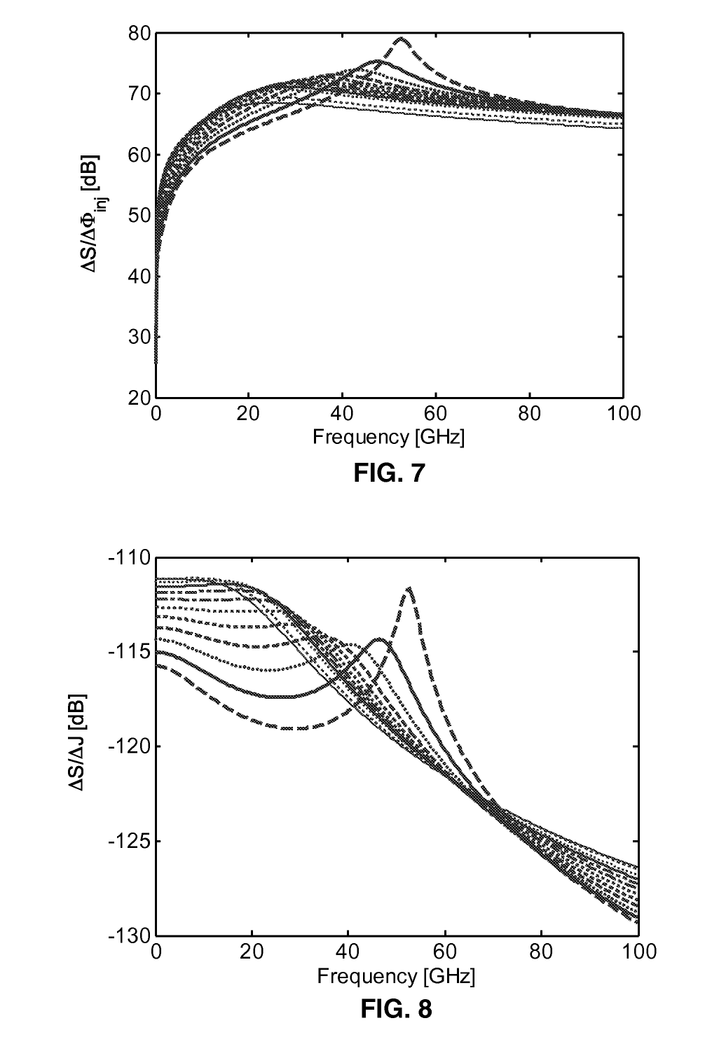

FIG. 6 and FIG. 7 represent phase modulation input for modulating phase and amplitude, respectively. The difference between these outputs lies only with the general shape of each frequency response. Table 1 describes possible modulation formats which can be utilized on the master laser, plus the resultant modulation formats that can be detected. It should be noted that direct modulation (DM) of the slave laser current is also shown for the sake of completeness.

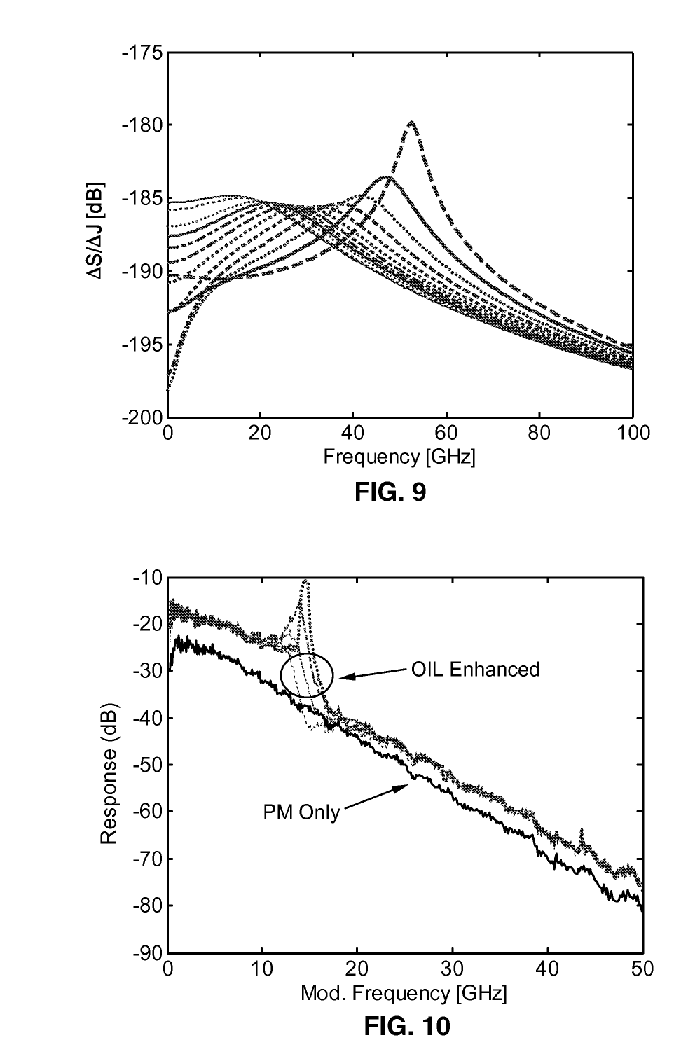

FIG. 5 through FIG. 9 depict representative frequency responses for many of the permutations of input and output modulation formats shown in Table 1. FIGS. 5-7 were discussed above. FIG. 8 illustrates AM frequency response to direct modulation of the slave laser. FIG. 9 illustrates PM frequency response to direct modulation of the slave laser. As shown, each format shows the same enhancement of resonance frequency, the only differences being in the general shapes of the curves. It will be appreciated that the ability to rely on these different forms of modulation provides flexibility of choosing a format which best suits a target application.

FIG. 10 illustrates an enhancement of phase modulation. The input and output signals are phase modulated. The signal is enhanced by a factor of about two to three over the entire frequency range. In addition, the signal below the peak frequency is amplified by at least a factor of ten over the input.

The cascading of the various modulation formats according to the present invention is readily implemented, with Table 1 showing the building-blocks for each stage of the daisy-chain. A designer can simply choose the blocks that they wish to cascade, matching the output modulation format of one block to the input modulation source of the next block. In a practical system, the origin of the modulation is electrical, wherein either an external amplitude or phase modulator, or direct modulation on an injection-locked laser, would be utilized as the first block. Finally, the output of the last cascaded block may be detected as either AM, PM, or FM. In addition, the initial electrical modulation can be applied to multiple blocks within the cascade. For example, it may be desirable to externally modulate the AM of the master laser while simultaneously directly modulating the next laser in the cascade. This would effectively multiply the response of the AM-to-AM with the response of the direct modulation-to-AM, possibly leading to superior response. Phase modulation may be achieved on the slave laser directly by integration of a phase section. It should also be noted that there are no constraints on the inventive technique with regard to the type of laser utilized for either the master or the slave laser(s); as these devices can be implemented as DFB, VCSEL, simple Fabry-Perot lasers, or even microring-cavity laser for integration purposes, as well as other laser device types and combinations thereof.

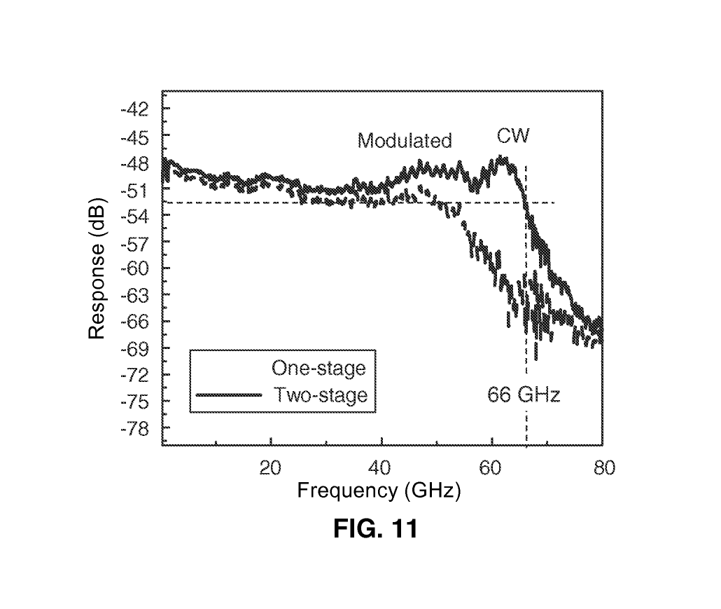

FIG. 11 illustrates a frequency response for an additional implementation configured according to the present invention. This implementation follows a similar setup as described for FIG. 1A except that the 1.55 μm VCSELs are mounted on copper blocks which are temperature controlled, in this case by thermal electric coolers (TECs). The emitted light is then coupled into a tapered fiber, wherein it can be more readily injection-locked through an optical circulator. A polarization controller is used in this implementation to match the master polarization to the VCSEL preferred polarization toward maximizing the locking stability. Biasing and modulation signals are delivered to the VCSELs through high-speed probes. A photo-detector with 70-GHz bandwidth is used for measurements. The test setup is shown as in FIG. 1A in which the first slave VCSEL is under direct current modulation. FIG. 11 shows the measured frequency response using Agilent E8361A network analyzer. The dashed line (lower) is the response from the first OIL stage only, under an injection ratio of ˜14 dB. The second VCSEL is injection-locked with an injection ratio of ˜16 dB. As expected, the response of a two-stage OIL is ameliorated in this setup as shown in the solid line (upper) which achieves a 3-dB bandwidth of 66 GHz.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

TABLE 1
Modulation Source and Output Combinations

| Modulation Source | Modulation Output |
|---|---|
| DM on laser | AM on injection-locked light |
| DM on laser | PM on injection-locked light |
| DM on laser | FM on injection-locked light |
| AM on injected light | AM on injection-locked light |
| PM on injected light | PM on injection-locked light |
| PM on injected light | AM on injection-locked light |
| FM on injected light | FM on injection-locked light |
| FM on injected light | AM on injection-locked light |
| AM on injected light | FM on injection-locked light |

(DM—Direct Modulation; AM—Amplitude Modulation; FM—Frequency Modulation; PM—Phase Modulation)

What is claimed is:

1. An apparatus for optical transmission, comprising:
a master laser which supports optical injection locking (OIL);
at least one slave laser cascaded upon said master laser;
said slave laser supporting optical injection locking (OIL) and configured for being injection locked by said master laser;
means for frequency detuning a first slave laser and any subsequent slave laser within said at least one laser;
wherein said detuning is performed across the locking range of the associated laser; and
means for modulating the input of said master laser and each subsequent slave laser.

2. An apparatus as recited in claim 1, wherein the cascaded configuration increases the available bandwidth for optical transmission.

3. An apparatus as recited in claim 2:
wherein a very high-frequency response is provided in response to use of relatively low-frequency devices; and
wherein said high-frequency response is on the order of at least 2-5 times the frequency of the 3-dB point bandwidth of said low-frequency components.

4. An apparatus as recited in claim 1:
wherein available bandwidth is increased with resonance peaks created for each said slave laser connected in cascade with said master laser; and
wherein total frequency response is provided in response to RF amplification from the shifted slave laser devices.

5. An apparatus as recited in claim 1, wherein said optical injection locking is performed in response to the use of optical circulators or power splitters.

6. An apparatus as recited in claim 1, wherein the optical elements in said apparatus are configured for maintaining or controlling polarization.

7. An apparatus as recited in claim 1, wherein said master laser provides sufficient power to lock onto the slave laser that has the largest detuning value.

8. An apparatus as recited in claim 1, wherein the means for modulating the master laser is either a direct or external modulation means.

9. An apparatus as recited in claim 8, wherein said external modulation is performed in response to the operation of an interferometer.

10. An apparatus as recited in claim 1, wherein first said slave laser is configured for direct modulation.

11. An apparatus as recited in claim 1, wherein said master laser and said at least one slave laser can be modulated according to either amplitude modulation (AM), phase modulation (PM), or frequency modulation (FM).

12. An apparatus as recited in claim 11, wherein the output modulation format of one slave laser is matched to the input modulation source of the next slave laser.

13. An apparatus as recited in claim 11, wherein the master laser is externally modulated and said at least one slave laser in the cascade is directly modulated.

14. An apparatus as recited in claim 1, wherein said optically injection-locked (OIL) laser is selected from within the group of semiconductor lasers consisting of distributed feedback lasers (DFB), vertical cavity surface-emitting lasers (VCSELs), Fabry-Perot lasers, and microring-cavity lasers.

15. An apparatus as recited in claim 1, wherein said injection-locked laser (OIL) provides single-sideband amplification of the modulation.

16. An apparatus as recited in claim 1, wherein said detuning between the master and the slave can be modulated along with injection power level to tailor frequency response toward either damped low resonance frequency or peaked high resonance frequency.

17. An apparatus for optical transmission, comprising:
a master laser which supports optical injection locking (OIL);
at least one slave laser cascaded upon said master laser to increase the available bandwidth for optical transmission;
said slave laser supporting optical injection locking (OIL) and being configured for being injection-locked by said master laser;
said master laser is electrically modulated and provides sufficient power output to lock onto the slave laser that has the largest detuning value;
means for frequency detuning a first slave laser and each subsequent slave laser within said at least one laser;
wherein said detuning is performed across the locking range of the associated laser; and
means for modulating the input of said master laser and cascaded slave lasers, whereby the optical transmission output of said apparatus comprises modulation of said master laser with bandwidth extending for each of said slave lasers.

18. An apparatus as recited in claim 17:
wherein said master laser and said at least one slave laser can be modulated according to either amplitude modulation (AM), phase modulation (PM), or frequency modulation (FM); and
wherein the output modulation format of one slave laser is matched to the input modulation source of the next block.

19. An apparatus as recited in claim 17, wherein said optically injection-locked (OIL) laser is selected from lasers selected from the group of semiconductor lasers consisting of distributed feedback lasers (DFB), vertical cavity surface-emitting lasers (VCSELs), Fabry-Perot lasers, and microring-cavity lasers.

20. A method of increasing bandwidth of an optical transmission, comprising:
configuring a master laser for optical injection locking (OIL);
connecting at least one slave laser to the master laser;
optical injecting locking of said at least one slave laser in response to injection locking by said master laser;
frequency detuning a first slave laser and each subsequent slave laser within said at least one laser;
wherein said detuning is performed across the locking range of the associated slave laser; and
modulating the input of said master laser and cascaded slave lasers whereby the optical transmission output of said method comprises modulation of said master laser and each of said slave lasers.
